(19) United States
(12) Patent Application Publication
(10) Pub. No.: US 2004/0197736 A1
(43) Pub. Date: Oct. 7, 2004

(54) Manufacture of moulded dentures

(76) Inventor: Nigel James Knott, Chippenham (GB)

Correspondence Address: SMITHKLINE BEECHAM CORPORATION, CORPORATE INTELLECTUAL PROPERTY-US, UW2220, P. O. BOX 1539, KING OF PRUSSIA, PA, 19406-0939, US

(21) Appl. No.: 10/416,405

(22) PCT Filed: Nov. 8, 2001
(86) PCT No.: PCT/GB01/04975

(30) Foreign Application Priority Data
Nov. 13, 2000 (GB) 0027654.3

(51) Int. Cl. A61C 13/00; A61C 11/00

(52) U.S. Cl. 433/167; 433/213; 433/214

(57) ABSTRACT

A polymerisable resin injection moulded denture is manufactured by making a first impression in a stock impression tray and producing a first cast model therefrom, providing a second impression tray special to the patient by forming a thermo plastic resin sheet on the first cast model, the resin sheet being such as to provide stability equivalent at least to that of 0.75 mm of stainless steel sheet, using said second impression tray with suitable adhesive to take a second accurate impression in silicone-free alginate impression material giving set volume stability to within 0.005% and from it making an accurate model die upon which a way replica denture is constructed and a mould thereof is produced of dental gypsum in a special flask which during injection moulding is subjected to progressive adjustment of clamping pressure between mould halves with rising injection pressure.

This invention relates to a system for the manufacture of moulded dentures and relates especially but not exclusively to injection moulding of polymerisable resin dentures.

The construction of dentures which give the wearer the necessary comfort, function and confidence is an exceptionally difficult task, possibly the most difficult in dentistry that hitherto is carried out with a selection of materials and methods that lack consistency and quality control. Known techniques of denture construction therefore frequently incorporate faults that result in prostheses that are uncomfortable, fragile, poorly fitting, unstable, of artificial appearance and sometimes allergenic.

Many previous proposals of improvements frequently refer to novel moulding methods or apparatus which could comprise one aspect of a manufacturing process but they have made neither any lasting impact nor led to material change in current conventional manufacturing technique.

In current techniques a mouth impression of each denture bearing area may first be taken in an alginate material and reproduced as a first plaster model of the patient's mouth, i.e. upper and/or lower jaws. This model may be employed as a basis upon which to produce a special or customised impression tray. This special tray is then used to take a more precise second alginate impression that is used to produce a higher quality dental stone die. Occlusal registration blocks are produced for upper and lower jaws to form a basis for the location and setting of artificial teeth. Working models are mounted on to an articulator and artificial teeth are set in position and a wax replica denture is made. After trying the wax replica denture or dentures in the mouth of the patient, each is then set in a plaster investment in half a denture flask with the teeth protruding therefrom. When the investment has hardened, the surfaces are coated with a release medium. The remaining half of the flask is assembled to the first half containing the wax replica denture and filled with more plaster investment to contain the protruding teeth to complete the mould. After setting of the gypsum mould the complete denture flask and mould is immersed in boiling water for a short period to melt the wax, the two halves are then separated and the wax is eliminated with boiling water and detergent. All surfaces, apart from the teeth now set in one half of the flask, are coated with a mould sealant prior to reassembling and moulding acrylic resin dough in the flask by compression prior to polymerisation. For a complete set of dentures such procedure applies to each denture.

Many sophisticated attempts have been made to improve such techniques which are frequently accompanied by well recognised faults. Some such attempts seek to use improved injection moulding.

The specifications of UK Patent Specification No. 2806253 and German Patent Specification No. 2312934 describe techniques involving heating gradients and directional polymerisation with rapid processing cycles, obtaining precise dental moulding from heat polymerised acrylic resins with pressure injection.

German Patent Specification No. 2312934 describes an enclosure for a denture mould which creates a temperature gradient when partially immersed in boiling water. The intention thereof is that polymerisation commences at points furthest from an injection channel and as this progresses the shrinkage of the resin is compensated by a flow of more material that enters the mould under pressure. A temperature of 100° C. is recommended for 35 minutes. However, the flask and moulds are highly stressed mechanically and the operating conditions can lead to distortion or even fracture of the moulds poor surface quality and low impact strength of resultant dentures. The resultant moulding has areas of differing thermal history and high levels of unconverted methyl methacrylate monomer close to the injection sites The denture bases can deform over a period of time as a result of the differing thermal history of the processed acrylic polymer and lack durability.

In U.S. Pat. No. 2,806,253 a procedure is proposed in which a mould is filled with a monomer-polymer mixture and then closed following which heat is applied selectively through the cast to initially polymerise that portion of the mixture which forms the tissue bearing surface of the dental prosthesis.

A further United Kingdom Patent Specification No. 2159457 described an injection moulding procedure in which the temperature of water in which the mould is immersed is first raised to 66° C. and held for period prior to raising to near-boiling temperature of the water to complete the polymerisation. Even though this latter procedure applied heat in a wet environment was more satisfactory than earlier techniques, it presented problems especially with regard to the possibility of leakage of resin material from the mould and with the quality of resultant prosthetic appliances.

The present invention seeks to introduce a system involving materials and apparatus that brings significantly better clinical results and patient satisfaction with consistency.

According to the present invention there is provided a system of manufacturing a required moulded denture for a patient including—

a preliminary diagnostic inspection of the patient.

taking a first impression of the denture bearing area of the mouth using a stock impression tray and producing therefrom first preliminary cast gypsum model.

using said first cast model to form a resin sheet material into second special impression tray customised to the anatomy of the denture bearing area of the mouth, and conforming to a stability specification at least equivalent to the elastic modulus of 0.75 mm of stainless steel plate.

applying a suitable adhesive to the special impression trays followed by an impression material which sets with a linear change of less than 0.05% and remains stable for a period of at least one hour.

using said second tray and impression material to take a second special impression of—the denture bearing area.

producing therefrom a master die from a material with a linear change of less than 0.1% on setting.

using the master die to create a trial wax replica denture.

checking said wax replica denture in the patient's mouth and where appropriate positioning upper incisor and canine teeth.

positioning other required teeth on the replica denture prior to setting in dental stone to create a mould for material of the moulded denture and

moulding the required denture therein.

Preferably the impression material is at least in accordance with BS 4269 Pt 2 1991:ISO 1563:1990 but with the additional characteristics that the material is silicone free and exhibits linear dimensional change after one hour of less than 0.05%.

Preferably gypsum material for said master die is at least as specified in accordance with BS EN ISO 6873:200 but with an additional requirement that the setting expansion after two hours is less than 0.1% and remains stable.

Preferably the denture base material is specified in accordance with BS EN ISO 1567 :1995 but with In additional requirement that residual monomer remaining in the processed denture does not exceed 0.15% and that the notched impact resistance of the processed denture material is not less than 3.75 Kj/m² using a Zwick testing machine with a 1.5 J pendulum/tup. The test specimens are to be 6×4×500 mm and notched with a 45 degree V notch in accordance with BS 2782, where the depth below the notch is 3.2 mm.

Preferably the mould is produced in a flask comprising two half bodies formed of polyetheretherketone or a material of which the thermal coefficient of expansion, mechanical properties and the thermal conductivity properties are similar to those of polyetheretherketone.

According to a further aspect of the invention there is provided a system of manufacturing mouldings by injection of polymerisable moulding material into a mould, including the steps of preparing a said mould in two parts to have a mould space of desired shape and dimensions, rendering the inner surfaces of said mould releasable from the moulding to be made, connecting the mould space to a container of said polymerisable material, applying injection pressure to said container of material to cause said material to flow into said mould whilst applying predeterminedly related fluid pressure to said mould in a sense to urge said parts together against the injection pressure within the mould and applying heat to said mould in a dry environment to effect polymerisation with a controlled temperature cycle.

Preferably said controlled temperature is maintained for a main polymerisation period followed by a further period at a temperature in excess of 100° to eliminate residual monomer to a level of less than 0.15%.

Preferably a predetermined pressure is applied to said mould before said injection pressure is applied to said container of material.

Preferably said heat is applied via thermally conducting members via which said predetermined related pressure is applied to said mould.

The present invention further provides a mould container especially for injection moulding of dental prostheses using polymerisable moulding material into an investment mould, the container comprising two half-bodies having generally frusto-conical spaces and being mouldable with their bases together to define a space for receiving investment material of the mould, the outer ends of said half-bodies being provided with opposing pressure plates which act as closures for the half-bodies and when assembled can permit graduable inward pressure dependent axial displacement.

Preferably, said pressure plates are provided with tapered axial spigots which locate in said ends to present the axial resistance to said axial displacement.

Said pressure plates are preferably of appreciably higher thermal conductivity than said half-bodies and said half-bodies have relatively low coefficient of thermal expansion.

The system of the invention can embrace every aspect of a denture manufacturing cycle, materials: clinical and technical protocols enabling converting wax replica dentures into precisely-fitting, stable, durable, non-allergenic and natural looking prosthetic appliances which will give much greater comfort and patient satisfaction. The benchmarked quality assured programme of materials combined with a reproducible manufacturing method can provide uniformity and consistency of product. Materials suitable for use in the manufacturing system will be available under the “ACCORD” (Registered Trade-Mark).

In order that the invention may be more clearly understood and readily carried into effect, a system for manufacturing a set of dentures and injection moulding apparatus will now be further described by way of example with reference to the accompanying drawings of which:

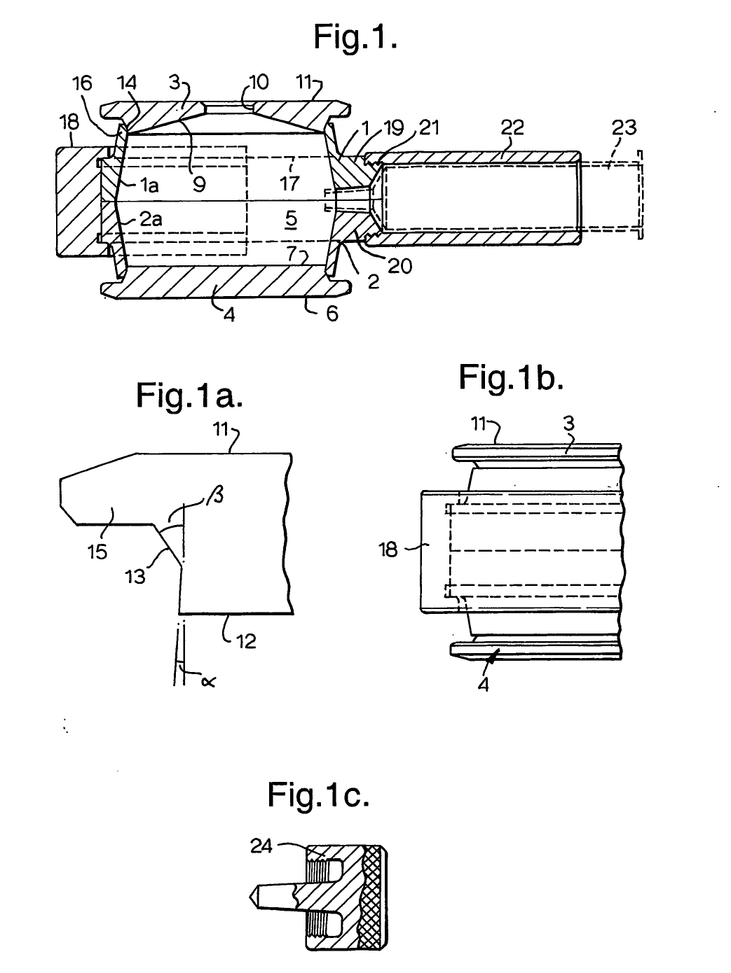

FIG. 1 illustrates in sectional view an assembled moulding flask.

FIG. 1a illustrates on an enlarged scale a fragment of part of FIG. 1.

FIG. 1b illustrates a fragmental end view of the flask of FIG. 1.

FIG. 1c illustrates a dummy nozzle for use with the flask.

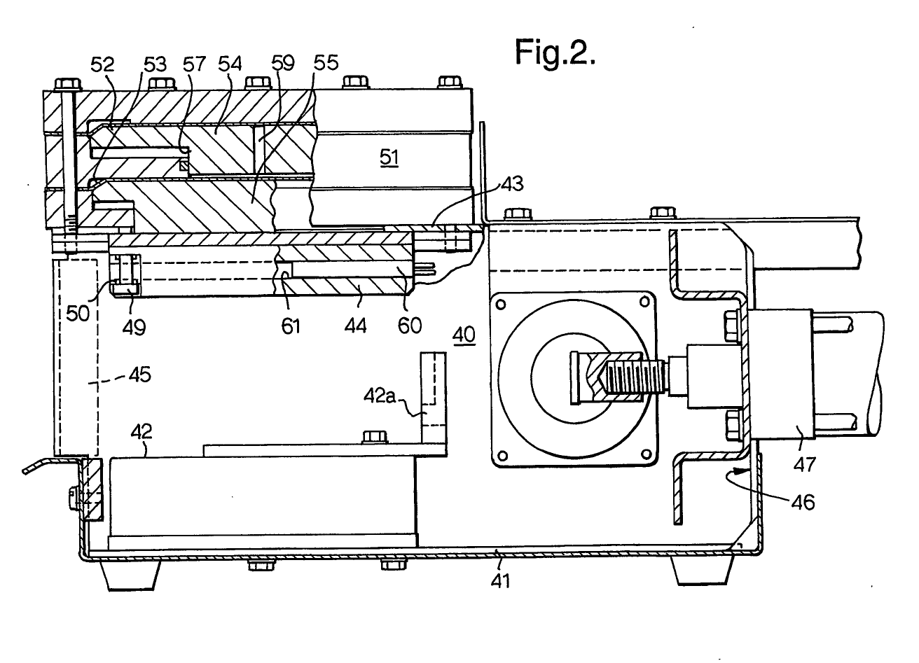

FIG. 2 illustrates a plan or sectional diagrammatic view of a pneumatic injection moulding apparatus.

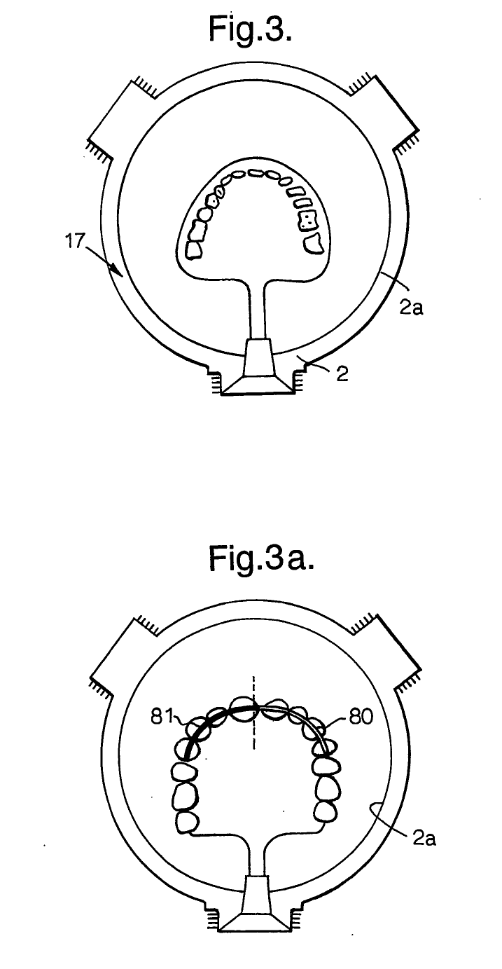

FIGS. 3+3a illustrate a half of a mould in plan view.

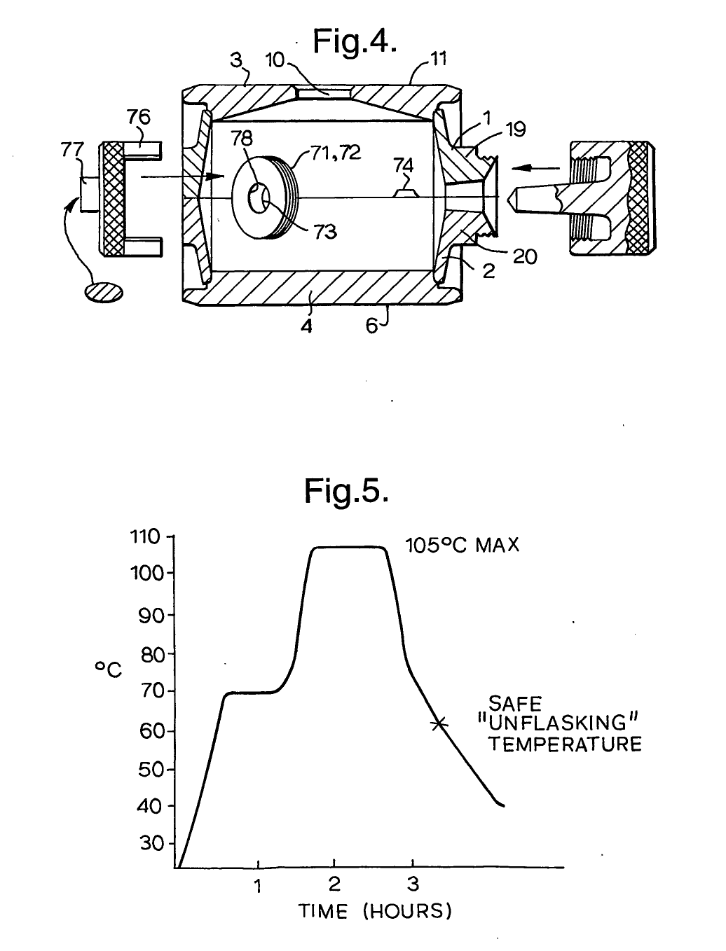

FIG. 4 illustrates a variant of the flask of FIG. 1 and

FIG. 5 illustrates a time and temperature diagram.

A preferred system of manufacture involves a succession of steps to be taken by a dental practitioner and a dental technician for producing the or each required denture. A case history is recorded and a diagnostic inspection is made of a patient's mouth and any existing dentures. A stock impression tray is chosen as one generally approximating to the patient's jaw dimensions. This chosen impression tray is used in conventional manner to take a first impression of the denture bearing area of a respective jaw and a first model is cast therefrom. The first cast model is then used to form from a thermoplastic resin sheet material blank a second impression tray special to the patient. The resin sheet material conforms to a specification such that the resultant tray has a pre-determined stability in use that equates to the elastic modulus of 0.75 mm of stainless steel plate.

Using the second impression tray together with an adhesive which securely bonds the impression material thereto, a second highly accurate impression is now taken in the preferred impression material which is silicone free and sets with a linear change of no more than 0.05% for up to one hour. After careful removal of the tray and its secured impression a second accurate cast stone model of an approved material is produced within a predetermined time using a gypsum stone material that shows a dimensional change not exceeding 0.1%.

The accurate cast model is employed to create a replica wax denture. First a wax base of an approved wax sheet material is formed and this is introduced to the patient's mouth. In the case of the upper jaw, selected artificial anterior teeth of an approved standard are located in the correct position with the aid of phonetic sounds and reference points are set for posterior teeth. An occlusal registration is taken to ascertain correct relationship between the upper and lower jaws. The mouth models are transferred with the wax base plates and registration records to an articulator for precise positioning in the correct relationship between upper and lower jaws. The or each wax replica denture is then constructed, the remaining teeth being set in position. The or each wax replica is tried into the patient's mouth, any errors in tooth position or occlusion are corrected and the wax replica being retried in the mouth as necessary. The or each replica is then waxed down on the master die model and invested in dental gypsum to create the mould or moulds for converting the respective wax replica form into a permanent resin denture in apparatus described below. Referring to FIG. 1 an assembled mould container or flask is shown in sectional manner. The container is generally circular and comprises four main components. Respective mutually close-fitting upper and lower half-bodies denoted by references 1 and 2 with planar interfaces are formed of a material, preferably polyetheretherketone which is of relatively low thermal conductivity, relatively low thermal expansion coefficient and is highly resistant to deformation. These half-bodies are made by machining or by precision moulding and finished to present substantially identical polished frusto-conical inner surfaces 1a and 2a and when placed together with the planar faces of the larger diameter ends abutting and with respective upper and lower pressure plates 3 and 4 assembled, they define an enclosure 5 within which gypsum investments can be set. The lower pressure plate 4 has parallel planar inner and outer surfaces 6 and 7 and the upper pressure plate 3 is similar but formed with a surface 9 leading via a central aperture 10 through the outer surface 11. Both pressure plates are designed to offer snap fitting into the respective half-bodies and as shown on a larger scale in FIG. 1a This is effected by a reverse angle “alpha” of about 20, the end 12 requiring pressure to insert it in the respective outer end of the respective half-body. Their peripheries also present engaging conical surfaces 13 at an angle of “beta” approximately 27° complementary to annular engaging surfaces 14 of the half-bodies. In an uncompressed condition, peripheral flanges 15 of the pressure plates thereby stand clear of outer end faces 16 of the half-bodies but they serve to permit compression of the mould but limit to 0.5 mm the maximum compression that may be effected on the contained gypsum investments in the apparatus to be further described.

The peripheries of the two half-bodies are provided with generally cylindrical regions which present external surfaces indicated as references 17 for closely receiving a semi-circular retaining member 18 which can slide into an operative position as shown also in FIG. 1b approximately diametrically opposite an injection boss. The injection boss is formed of complementary projections 19, 20 one of each half-body, and it carries an external screw threaded region 21, for receiving a screw-on tubular injection syringe container tube 22 for receiving an injection syringe 23 as shown by broken outlines and alternatively a screw-on dummy-nozzle 24 as illustrated in FIG. 1c.

The assembled mould container of FIG. 1 is receivable in a pneumatically operable injection moulding apparatus as illustrated in part-sectional manner in FIG. 2. This comprises a rigid housing 40 of generally rectangular shape having a base 41 carrying a fixed lower heat conducting platen 42 and a roof 43 carrying a moveable upper heat conducting platen 44 and generally parallel facing platen 42. The housing 41 has a front opening 45 shown at the left of FIG. 2 of such dimensions as to freely receive the assembled mould container and a guide member 42a for location between upper and lower platens 42 and 44. A rear wall 46 of housing 40 accommodates a piston and cylinder assembly 47 of a first pneumatic ram having an inwardly directed plunger head 48 (shown retracted) engagable with an injection syringe such as 23 positioned in the syringe container tube 22 (FIG. 1). Whilst the lower platen 42 is rigidly bolted to the interior of the base of the housing 41, the upper platen 44 is resiliently supported at the top of the housing by three spaced members such as 49 with captive return springs such as 50 urging the platen 44 upwards towards its retracted position as shown. Mounted to the outside of the top of the housing there is a second pneumatic ram assembly 51 which comprises a pair of diaphragms 52, 53 and respective push plates 54, 55. The push plates 54 and 55 are arranged to act in series, the upper one having a spigot 57 projecting sealingly slideably through an intermediate wall 58 to engage the upper surface of lower diaphragm 53. The respective push plate 55 of the latter in turn projects through the housing to directly engage the upper platen 44 in a sense to urge it downwards from its said retracted position. The upper push plate 54 and diaphragm 52 are mutually sealed together and a passage 59 inter communicates the upper surfaces of both diaphragms so that when acted upon by compressed air their effective areas are additive. These effective areas comprise the annular area outside the spigot 57 for the upper diaphragm and the entire area of the lower diaphragm, in engagement with the respective push plates. In order to provide dry heating, each of the platens is provided with two rod-like electric heating elements such as indicated at 59 located in drillings such as indicated by reference 60.

Referring to FIG. 4 of the drawings, means alternative to the semicircular retaining member 18 is shorn. In this case in addition to the injection boss formed on half-bodies 1 and 2, similar but blank bosses 71, 72 spaced angularly at 60° to the injection boss. These two bosses are provided with detachable threaded caps 76 which when in place co-operate to hold the two mould halves together. Further precision in this is provided by positioning details and corresponding recesses two of which are shown at 73 and 74 and provide immediate alignment of the reassembled flask halves. Further, to facilitate separation of the flask-halves the caps 76 have oval projections 77 which can loosely enter corresponding recesses 78 on the blank bosses. Manual turning of these effects a cam action to ease the halves apart after removal of plugs 24 and caps 76.

In the preferred injection moulding method achievable with apparatus described in the foregoing, the gypsum material exhibits low thermal dimensional change. Such material is available under the name “Accord” (Registered Trade Mark).

Thus each finally adjusted wax replica of the intended denture is set into a cast in the lower half body 2 as now seen in plan view in FIG. 3 together with a sprue piece (if necessary in addition to dummy nozzle 24) to produce a convenient injection channel. The interface of the set gypsum is then treated with a sealant before attachment and alignment with the upper half body 1 together with clamping member 18 and the dummy nozzle 24 is screwed in place. The remaining space within the flask is then filled with further gypsum material through the open aperture of the upper half-body and the upper pressure plate 3 is pressed into a snapped in position causing excess material to be expelled via aperture 10. This excess is levelled off across the outer surface of plate 3. After setting of the gypsum the flask is immersed in hot water to soften the wax before dismantling, by separating the two halves and cleaning away all traces of wax. A sprue passage or passages are cleared as necessary before reassembly and the surfaces except the teeth are coated with a mould sealant.

As indicated in FIG. 3a, channels 80 are cut in the protruding bases of the central incisors, lateral incisors, canines, and first premolars retained in the sealed mould half. These grooves receive and locate a resin-pre-impregnated carbon fibre rope 81 of 12 thousand 5 micron diameter filaments, to provide enhancement of the mechanical strength of the eventual moulding. The thus located carbon fibre rope can be lacquered if necessary to obscure any visible dark line.

The two mould halves are then replaced together and mounted in the apparatus of FIG. 2 with dummy nozzle 24 replaced by the tubular syringe container 22. A syringe 23 charged with a suitable quantity of the preferred polymerisable material followed by a piston (not shown) is then positioned in the tube 22. Preferably the polymerisable resin base material comprises approximately 10 mls of monomer to every 18 gms of polymer. Preferably these comprise methylmethacrylate monomer and polybutadienestyrene particle reinforced polymethylmethacrylate beads respectively but other suitable materials or compositions of such materials may be employed. In the present example the notched impact resistance of the eventual processed material is required to exceed 3.75 Kj/m². When the thus assembled mould container is inserted into the injection moulding unit housing 40 the plunger head 48 locates with the syringe 23 and the plates 1 and 2 are aligned with platens 42 and 44 which are at ambient temperature (say 20° C.). Operation of a control switch results in compressed air being applied first to the second pneumatic actuator 51 up to a controlled pressure level which is sufficient to apply a compressive force between plates 3 and which is at least sufficient to grip the two halves of the mould and to thereby ensure initial virtually resin fluid tight sealing at the interface between the two “halves” of the mould but without causing any distortion of the mould space. This pressure also firmly positions the mould container before injection commences. Operation of a further switch then results in application of compressed air at approximately 90 psi to the first pneumatic actuator 47 to drive the head 48 against the piston (not shown) of the injector and begin the flow of the material from the injector into the mould space. Air is thereby expelled via the porosity of the gypsum. Simultaneously the clamping pressure applied by 51 is proportionally increased having regard for the relative areas of the syringe and the assembly 51 to ensure continued sealing between the moulded halves. Meanwhile the temperature of the plates 3 and 4 is increased by the platens 42 and 44 towards 70° C. When temperature stability is achieved the mould having attained 70° C. the temperature is maintained thereat for a main period of approximately 3/4 hours following which the temperature is further raised to a higher value of about 104° C. and maintained for 1.5 hours to ensure the required elimination of residual monomer. The main polymerisation period at 70° C. ensures controlled polymerisation without boiling of the monomer due to exothermic effects thereby avoiding porosity in the denture.

The mould temperature is then reduced with the aid (not shown) of fan cooling over a period of 30 minutes to a lower value accompanied by progressive reduction of the clamping pressure between platens 42 and 44 permitting eventual release of the mould container from the unit at a safe unflasking temperature of about 60° C. The two halves of the flask are then separated and the mould is “unflasked” allowing the moulded denture base to be carefully released from the mould for final adjustment and fitting to the patient.

Whilst not described in the foregoing the pneumatic actuator 47 may be provided with position indication means whereby an operator may readily first observe that the injector piston has moved to commence injection of material into the mould and secondly receive a warning in the event of excessive movement. Such excessive movement may be indicative of either insufficient material being present or of a leakage of material from the mould. Such signals may be provided for example by suitable positioned moveable microswitches to provide electrical and/or audible indications. For example a single warning light may provided if required which the operator can firstly observe to be extinguished by the open circuit condition of one microswitch and secondly to be relit via a closed circuit condition of a second microswitch.

In an alternative varient of the construction of the moulded dentures, instead of the transverse grooves 80 of FIG. 3a, the bases of the teeth may be provided with traverse apertures through which the impregnated reinforcement carbon fibre rope is threaded before moulding.

1 A system of manufacturing a required moulded denture for a patient including
preliminary diagnostic inspection of the mouth of the patient
taking a first impression of the denture bearing area of the mouth using a stock impression tray and producing therefrom a first preliminary cast model
employing said first cast model to form a resin sheet material into a second special impression tray customised to the anatomy of the denture bearing area and conforming to a stability specification at least equivalent to the modulus of 0.75 mm of stainless steel plate
applying a suitable adhesive to the tray followed by an impression material which sets with a volume change of less than 0.5%
using said second tray and impression material to take a second impression of the denture bearing area
producing therefrom a master die from a material with linear change of less than 0.1% on setting
using the master die to create a trial wax replica denture
checking said wax replica denture in the patient's mouth and where appropriate positioning upper incisor and canine teeth
positioning other required teeth on the replica denture prior to setting in dental stone to create a mould for material of the moulded denture and
moulding the required denture therein

2 A system of manufacturing a moulded denture as claimed in claim 1, the material of said master die being formulated to limit volumetric dimensional change to less than 0.1%.

3 A system of manufacturing a moulded denture as claimed in claims 1 or 2 when said impression material is silicone free.

4 A system as claimed in claims 1, 2 or 3 wherein the material of said moulded denture is a polymerisable resin comprising wherein residual monomer does not exceed 0.15% at any part.

5 A system as claimed in claims 1, 2, 3 or 4 said moulded denture being formed in said mould by compression moulding.

6 A system as claimed in claims 1, 2, 3, or 4 said moulded denture being formed in said mould by injection moulding.

7 A system as claimed in claim 6 including the steps of preparing said mould in two parts to provide a mould space conforming to the wax replica denture, rendering the inner surface of the moulded space releasable from the moulding to be produced, connecting the mould space to a container of polymerisable material applying injection pressure to said container to cause said material to flow into said mould whilst applying predeterminedly related pressure to the mould in a sense to urge said parts together against the injection pressure and applying heat to said mould to effect polymerisation at controlled temperature

8 A system as claimed in claim 7, where pressure is applied to said mould before injection pressure is applied.

9 A system as claimed in claims 6 or 7, wherein said temperature is created by dry heating means.

10 A system as claimed in claim 9 when said temperature is maintained at relatively low level for a predetermined period to provide slow polymerisation and raised to a relatively higher level for a further period to minimise free monomer in the moulding.

11 A system as claimed in any proceeding claims wherein bases of a foremost group of said teeth are formed to receive and locate reinforcement fibres before said moulding of the denture.

12 A system as claimed in claim 1 said bases of said teeth being formed with transverse grooves.

13 A system as claimed in claim 11 said bases of said teeth being formed with traverse apertures.

14 A system as claimed in claim 11, 12 or 13 said fibres being in a carbon fibre rope.

15 Moulding apparatus for manufacturing denture models including a mould container comprising two half-bodies having generally frusto-conical faces and being mountable with their bases together to define a space for receiving the investment material of the mould, the outer ends of said outer bodies being provided with opposing pressure plates which act as closures for the half-bodies and which when assembled can permit axial displacement and graduable inward pressure application to the mould.

16 Apparatus as claimed in claim 15 wherein said pressure plates are provided with integral tapered axial spigots which locate in said ends to present axial resistance to said axial displacement.

17 Apparatus as claimed in claim 16 wherein said spigots have snap-in end sections.

18 Apparatus as claimed in claim 15, 16 or 17 wherein said pressure plates are of appreciably higher thermal conductivity than said half-bodies and said half-bodies have relatively low coefficient of thermal expansion.

19 Apparatus substantially as described herein with reference to the accompanying drawings.

20 A system of manufacturing a moulded denture substantially as described.

21 A moulded denture manufactured using the system or apparatus as claimed in any preceding claim.
